(19) United States
(12) Patent Application Publication
(10) Pub. No.: US 2011/0008028 A1
(43) Pub. Date: Jan. 13, 2011

(54) LAMP AND HEATING DEVICE

(75) Inventors: Noriyuki Maeda, Yokohama-shi (JP); Kengo Iwahara, Machida-shi (JP)

Correspondence Address: OLIFF & BERRIDGE, PLC, P.O. BOX 320850, ALEXANDRIA, VA, 22320-4850, US

(73) Assignee: Nichias Corporation, Tokyo (JP)

(21) Appl. No.: 12/933,733

(22) PCT Filed: Mar. 27, 2009
(86) PCT No.: PCT/JP2009/056261

§ 371 Date: Sep. 21, 2010

(30) Foreign Application Priority Data
Mar. 31, 2008 (JP) 2008-090785

(51) Int. Cl. F27D 11/12; H01K 1/58

(52) U.S. Cl. 392/416; 313/47

(57) ABSTRACT

Provided are a lamp and a heating device which are capable of effectively preventing a seal portion from being overheated with a simple structure. A lamp includes: a tube portion in which a filament including a coil portion is contained; a seal portion filled with a metal foil connected to an end of the filament; and an overheat preventing portion covering a part of an outer surface of the tube portion.

### TECHNICAL FIELD

The present invention relates to a lamp and a heating device, and specifically, to preventing overheating of a seal portion of the lamp.

### BACKGROUND ART

When using a lamp including a seal portion in which a metal foil connected to an end of a filament is sealed, for example, a halogen lamp, the seal portion is overheated, and hence a life-span of the lamp is reduced.

For example, an in-line heater for heating a fluid, such as deionized water or a chemical solution for semiconductor manufacturing, includes a halogen lamp having a quartz glass tube in which a tungsten filament is housed. In the in-line heater, the halogen lamp is not brought into direct contact with the fluid to be heated. Therefore, it is more likely to overheat the seal portion which is an end portion of the quartz glass tube because of the heat from the tungsten filament. When the seal portion is overheated, the seal portion is deformed by the expansion of the metal foil, and hence outside air flows into the quartz glass tube. As a result, the tungsten filament of the quartz glass tube may be oxidized and thus degraded.

Therefore, for example, Patent Document 1 describes a heating device including a cooling pipe for guiding cooling air to an end portion of a halogen lamp.

Patent Document 1: JP 2003-97849 A

### DISCLOSURE OF THE INVENTION

### Problems to be Solved by the Invention

However, in the heating device described in Patent Document 1, the cooling pipe leads to a problem such as that the structure of the heating device being complicated and a large space being required for installing the heating device because the size of the heating device is increased.

The present invention has been made in view of the problem described above. An object of the present invention is to provide a lamp and a heating device which are capable of effectively preventing the seal portion from being overheated, with a simple structure.

### Means for Solving the Problems

In order to solve the above-mentioned problem, a lamp according to an embodiment of the present invention includes: a tube portion in which a filament including a coil portion is housed; a seal portion in which a metal foil connected to an end of the filament is encapsulated; and an overheat preventing portion covering a portion of an outer surface of the tube portion. According to the present invention, the lamp which is capable of effectively preventing the seal portion from being overheated with a simple structure may be provided.

The overheat preventing portion may be provided to cover a part of the outer surface of the tube portion which is closer to the end of the filament with respect to the coil portion of the filament. In this case, heat transfer from the tube portion to the seal portion may be effectively reduced to more effectively prevent the seal portion from being overheated. The overheat preventing portion may be formed to protrude to the outside of the tube portion in a diameter direction, so as to block light traveling from the coil portion which is generating heat to the seal portion. In this case, an increase in temperature of the seal portion due to radiation from the coil portion of the filament may be effectively suppressed to more effectively prevent the seal portion from being overheated. The overheat preventing portion may be made of ceramic. In this case, a fire resistance of the overheat preventing portion may be ensured and the seal portion may be effectively prevented from being overheated.

In order to solve the above-mentioned problem, a heating device according to an embodiment of the present invention includes any one of the lamps described above as a heating source. According to the present invention, the heating device which is capable of effectively preventing the seal portion of the lamp from being overheated with a simple structure may be provided.

The heating device may include a double tube portion including an inner cylindrical portion in which the lamp is housed and an outer cylindrical portion through which a fluid to be heated flows, and the lamp may be housed in the inner cylindrical portion so that the overheat preventing portion is in contact with the inner cylindrical portion and the seal portion protrudes to the outside of the double tube portion. Therefore, the seal portion of the lamp may be more effectively prevented from being overheated.

### BRIEF DESCRIPTION OF THE DRAWINGS

FIG. 1 A perspective view illustrating a lamp according to an embodiment of the present invention.

FIG. 2 A plan view illustrating the lamp according to the embodiment of the present invention.

FIG. 3 A side view illustrating the lamp according to the embodiment of the present invention.

FIG. 4 A cross sectional view illustrating a part of the lamp according to the embodiment of the present invention, which is surrounded by a broken line IV illustrated in FIG. 2.

FIG. 5 A cross sectional view illustrating a part of the lamp according to the embodiment of the present invention, which is surrounded by a broken line V illustrated in FIG. 3.

FIG. 6 A cross sectional view illustrating the lamp according to the embodiment of the present invention cut along the line VI-VI illustrated in FIG. 2.

FIG. 7 A side view illustrating a lamp assembly according to the embodiment of the present invention.

FIG. 8 A side view illustrating a heating device according to the embodiment of the present invention.

FIG. 9 An explanatory drawing illustrating an example of temporal changes in temperature of a seal portion and temperature of concentrated sulfuric acid, which are measured in a case where concentrated sulfuric acid is heated using the heating device according to the embodiment of the present invention.

FIG. 10 An explanatory drawing illustrating another example of temporal changes in temperature of the seal portion and temperature of concentrated sulfuric acid, which are measured in a case where concentrated sulfuric acid is heated using the heating device according to the embodiment of the present invention.

FIG. 11 An explanatory drawing illustrating an example of a temporal change in temperature of a seal portion which is measured in a case where concentrated sulfuric acid is heated using a heating device including a halogen lamp which does not include an overheat preventing portion.

### BEST MODE FOR CARRYING OUT THE INVENTION

Hereinafter, an embodiment of the present invention is described with reference to the attached drawings. Firstly, a lamp according to the embodiment of the present invention (hereinafter referred to as “the lamp”) is described. In this embodiment, an example in which the lamp is realized as a halogen lamp is described.

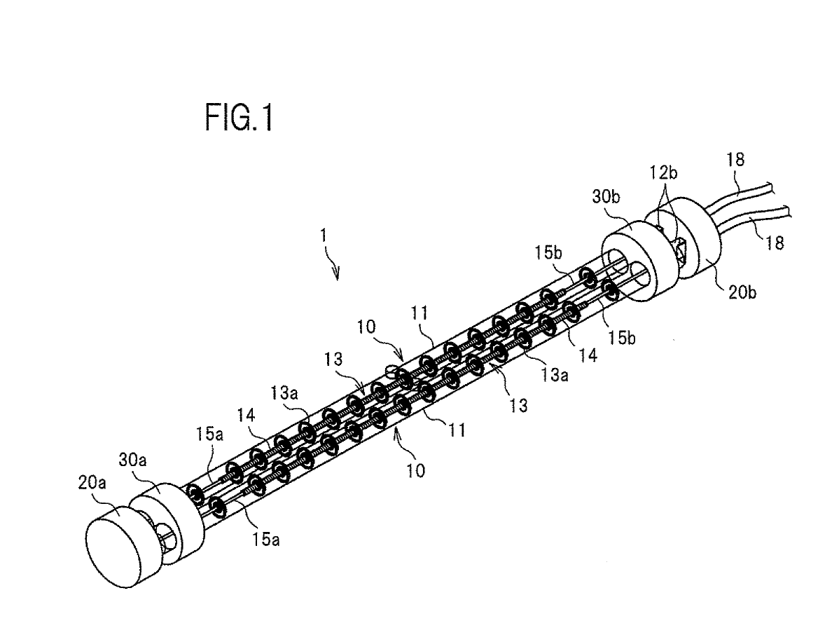

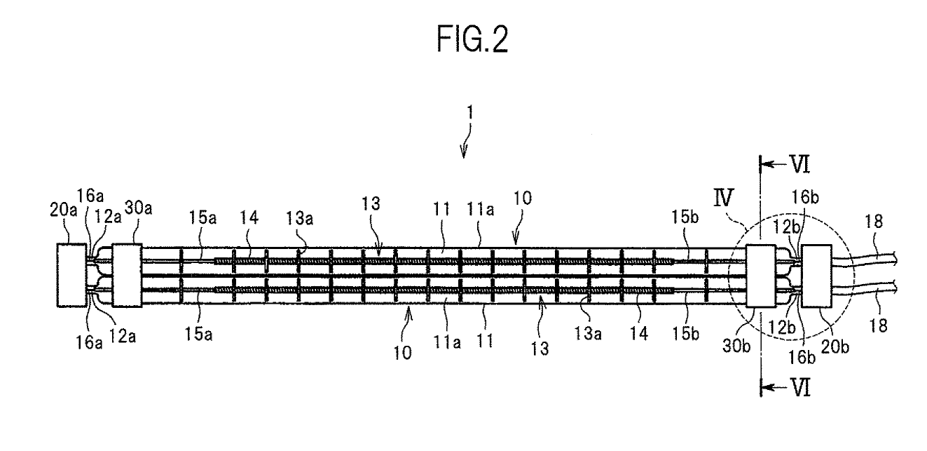

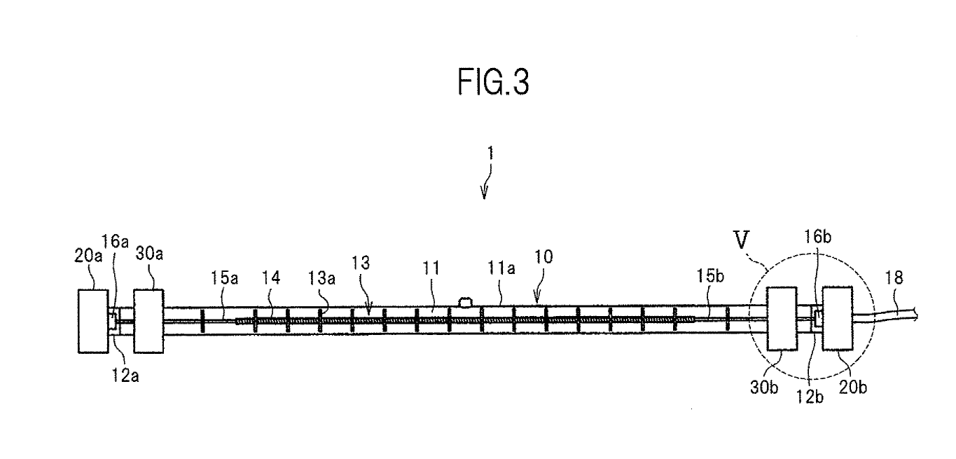

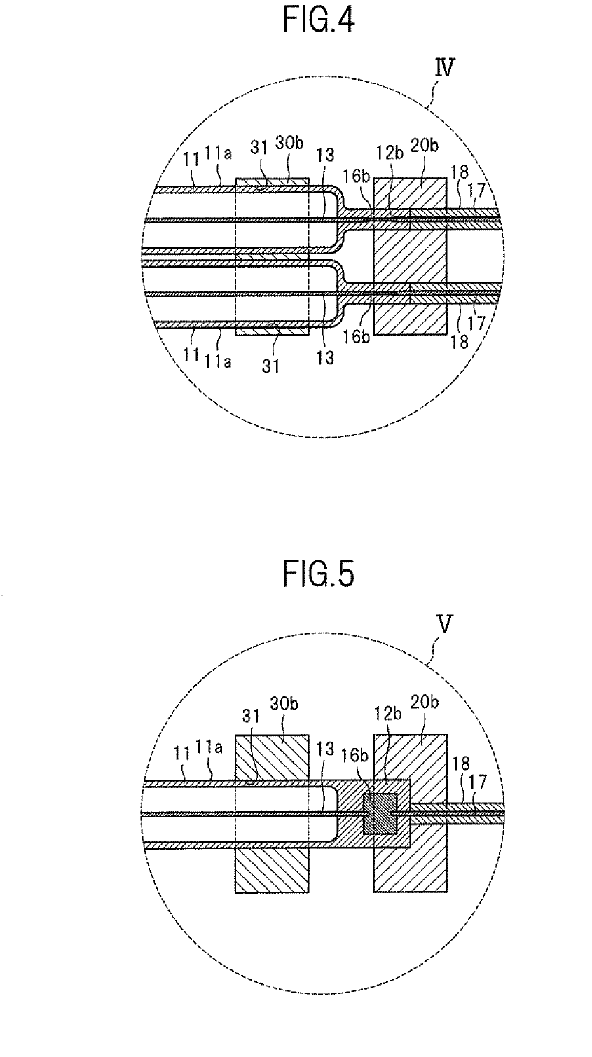

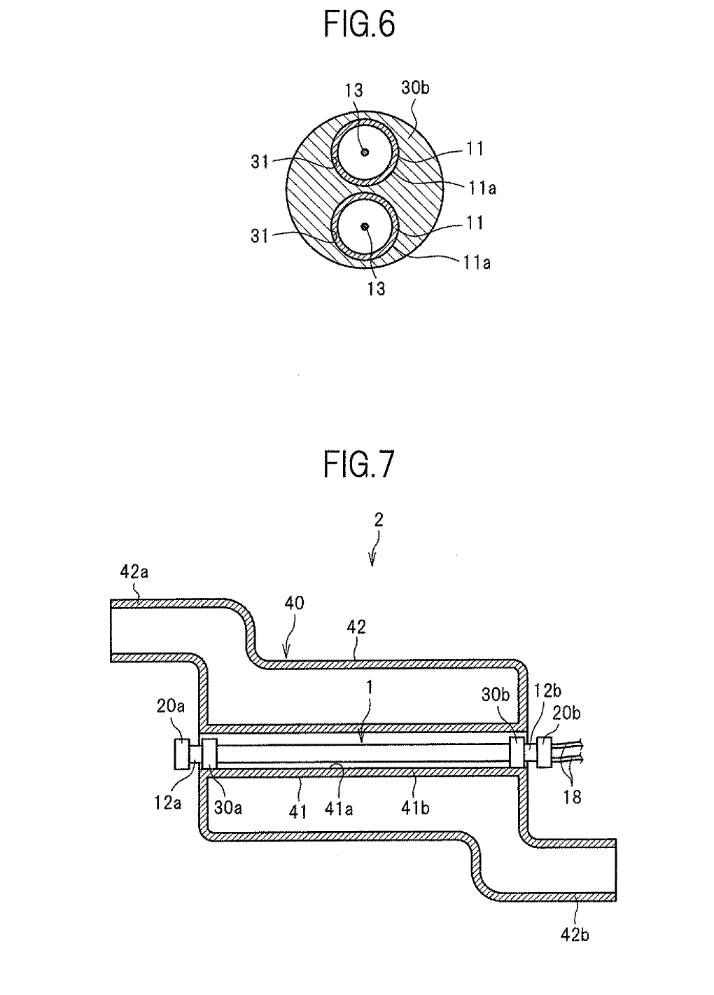

FIG. 1 is a perspective view illustrating a lamp 1. FIG. 2 is a plan view illustrating the lamp 1. FIG. 3 is a side view illustrating the lamp 1. FIG. 4 is a cross sectional view illustrating a part of the lamp 1, which is surrounded by a broken line IV illustrated in FIG. 2. FIG. 5 is a cross sectional view illustrating a part of the lamp 1, which is surrounded by a broken line V illustrated in FIG. 3. FIG. 6 is a cross sectional view illustrating the lamp 1 cut along the line VI-VI illustrated in FIG. 2.

As illustrated in FIGS. 1 to 3, the lamp 1 includes two lamp main bodies 10. A material of the lamp main bodies 10 is not specifically limited as long as light emitted from the lamp 1 transmits the material. In this embodiment, the lamp main bodies 10 are quartz glass tubes. The lamp main bodies 10 have hollow tube portions 11. The tube portions 11 are filled with inert gases and very small amounts of halogen gases.

A filament 13 is housed in each of the tube portions 11. A material of the filament 13 is not specifically limited as long as the material generates heat and light by current supply in the tube portion 11. In this embodiment, the filament 13 is a tungsten filament. The filament 13 has a coil portion 14 and two non-coil portions 15a and 15b. The coil portion 14 is a coil-shaped central portion of the filament 13. One non-coil portion 15a is one straightly extending end portion of the filament 13. The other non-coil portion 15b is the other straightly extending end portion of the filament 13. The filament 13 is supported by a plurality of support portions 13a made of ring-shaped metal wires to be located close to the center of the tube portion 11 in a diameter direction.

Each of the lamp main bodies 10 includes two seal portions 12a and 12b. One seal portion 12a corresponds to one end portion of the lamp main body 10. The other seal portion 12b corresponds to the other end portion of the lamp main body 10.

That is, the one seal portion 12a seals one end of the tube portion 11, and the other seal portion 12b seals the other end of the tube portion 11. The seal portions 12a and 12b are formed as follows. During manufacturing of the lamp main body 10, one end and the other end of the quartz glass tube are softened by heating and compression bonded for sealing.

As illustrated in FIGS. 4 and 5, metal foils 16a and 16b are encapsulated in the seal portions 12a and 12b. That is, the metal foil 16a connected to the one end of the filament 13 (that is, to the end of one non-coil portion 15a) is encapsulated in one seal portion 12a of each of the lamp main bodies 10. The metal foil 16b connected to the other end of the filament 13 (that is, to the end of the other non-coil portion 15b) is encapsulated in the other seal portion 12b of each of the lamp main bodies 10. In this embodiment, the metal foils 16a and 16b are molybdenum foils.

In the lamp 1, the two lamp main bodies 10 are provided in parallel and the end portions of the two lamp main bodies 10 are supported by insulation portions 20a and 20b. In this embodiment, the insulation portions 20a and 20b are made of ceramic and formed into a disk shape.

One insulation portion 20a is filled with the two seal portions 12a located on one side. The two metal foils 16a encapsulated in the seal portions 12a located on the one side are connected to conductive metal wires (not shown) in the insulation portion 20a.

The other insulation portion 20b is filled with the two seal portions 12b located on the other side. As illustrated in FIGS. 4 and 5, in the other insulation portion 20b, respective metal foils 16a encapsulated in the seal portions 12b are connected to external lead rods 17 which are conductive metal wires. In this embodiment, the external lead rods 17 are molybdenum wires. Two lead wires 18 extend from the insulation portion 20b, which are formed by coating the external lead rods 17 with an outer cover made of an insulating material.

As illustrated in FIGS. 1 to 6, the lamp 1 as described above includes overheat preventing portions 30a and 30b covering outer surfaces 11a of the tube portions 11. In this embodiment, as in the case of the insulation portions 20a and 20b, the overheat preventing portions 30a and 30b are made of ceramic and formed into a disk shape.

As illustrated in FIGS. 4 to 6, through holes 31 having a diameter substantially equal to an outer diameter of the tube portions 11 are formed in the overheat preventing portion 30b. The tube portions 11 are inserted through the through holes 31. The overheat preventing portions 30a and 30b cover the entire region of the outer surfaces 11a of the tube portions 11 in the circumferential direction.

The overheat preventing portions 30a and 30b are provided to cover parts of the outer surfaces 11a of the tube portions 11 which are located closer to end sides with respect to the coil portions 14 of the filaments 13. That is, one overheat preventing portion 30a is provided between the coil portions 14 of the filaments 13 and the seal portions 12a located on one side. Similarly, the other overheat preventing portion 30b is provided between the coil portions 14 of the filaments 13 and the seal portions 12b located on the other side.

The lamp 1 as described above emits light when one of the two lead wires 18 is connected to an anode of a power source and the other thereof is connected to a cathode of the power source to supply a current to the filaments 13. That is, the filaments 13 supplied with a current in the tube portions 11 generate heat and light. The lamp main bodies 10 are heated by heat and light which are generated from the filaments 13.

The lamp 1 includes the overheat preventing portions 30a and 30b described above, and hence specifically the seal portions 12a and 12b of the lamp main bodies 10 are effectively prevented from being overheated.

That is, in the lamp 1, the overheat preventing portions 30a and 30b are integrally provided with the tube portions 11, and hence a heat capacity of the lamp main bodies 10 is increased compared with a case where the overheat preventing portions 30a and 30b are not provided. Specifically, heat transferred from the filaments 13 to the tube portions 11 is consumed not only in increasing temperatures of the tube portions 11 but also in increasing temperatures of the overheat preventing portions 30a and 30b.

Therefore, increase in temperatures of the seal portions 12a and 12b after a current starts to flow into the filaments 13 is slowed compared with the case where the overheat preventing portions 30a and 30b are not provided. In addition, a temperature that the seal portions 12a and 12b reach is kept low to prevent overheating.

The overheat preventing portions 30a and 30b are provided in the tube portions 11, and hence heat transfer from the tube portions 11 to the seal portions 12a and 12b is effectively blocked by the overheat preventing portions 30a and 30b.

That is, the tube portions 11 containing the filaments 13 of the lamp main bodies 10 are heated with a higher priority than the seal portions 12a and 12b by heat and light which are generated from the filaments 13. Then, heat received by the tube portions 11 is subsequently transferred from the tube portions 11 to the seal portions 12a and 12b.

In the lamp 1, the overheat preventing portions 30a and 30b are provided between the parts of the tube portions 11 and the seal portions 12a and 12b, and hence heat transfer from the parts of the tube portions 11 to the seal portions 12a and 12b is suppressed by the overheat preventing portions 30a and 30b.

In this embodiment, specifically, the overheat preventing portions 30a and 30b are in contact with the entire region of the outer surfaces 11a of the tube portions 11 in the circumferential direction, and hence heat transfer from the tube portions 11 to the seal portions 12a and 12b is reliably blocked. As a result, the seal portions 12a and 12b are effectively prevented from being overheated.

In this embodiment, the overheat preventing portions 30a and 30b are provided to cover the parts of the outer surfaces 11a of the tube portions 11 which are located closer to the end sides with respect to the coil portions 14 of the filaments 13. Hence, the seal portions 12a and 12b are effectively prevented from being overheated.

That is, a heat generation amount and a light generation amount of the coil portions 14 of the filaments 13 are larger than those of the non-coil portions 15a and 15b. Therefore, the parts of the tube portions 11 which contain the coil portions 14 are more rapidly heated by the coil portions 14 than the other parts of the tube portions 11.

Therefore, because the overheat preventing portions 30a and 30b are provided closer to the seal portions 12a and 12b with respect to the parts of the tube portions 11 which contain the coil portions 14, the seal portions 12a and 12b are specifically effectively prevented from being overheated.

Specifically, in this embodiment, as illustrated in FIGS. 1 to 5, the overheat preventing portions 30a and 30b are provided in the parts of the tube portions 11 which contain the non-coil portions 15a and 15b.

Therefore, heat transfer from the parts of the tube portions 11 which contain the coil portions 14 to the seal portions 12a and 12b is reliably prevented. As a result, the seal portions 12a and 12b are effectively prevented from being overheated.

In this embodiment, the overheat preventing portions 30a and 30b are formed into a shape to protrude to the outsides of the tube portions 11 in the diameter direction in order to block light traveling from the heating coil portions 14 to the seal portions 12a and 12b. That is, the overheat preventing portions 30a and 30b are formed into the disk shape to be provided over the entire region of the outer surfaces of the tube portions 11 in the circumferential direction like a shade.

Therefore, radiation from the coil portions 14 to the seal portions 12a and 12b due to heat generation and light generation is blocked by the overheat preventing portions 30a and 30b. Thus, the increase in temperature of the seal portions 12a and 12b due to the radiation from the coil portions 14 of the filaments 13 is effectively suppressed to effectively prevent the seal portions 12a and 12b from being overheated. In this embodiment, the overheat preventing portions 30a and 30b are made of ceramic having excellent heat resistance, and hence the effects described above are reliably exhibited.

Next, a heating device according to this embodiment (hereinafter referred to as “the device”) is described. In this embodiment, an example in which the device is realized as an in-line heater using the lamp 1 described above as a heating source is described.

FIG. 7 is a side view illustrating a lamp assembly 2 including the lamp 1. FIG. 8 is aside view illustrating the device including the lamp assembly 2 illustrated in FIG. 7.

As illustrated in FIG. 7, the lamp assembly 2 includes the lamp 1 and a double tube portion 40. The double tube portion 40 includes an inner cylindrical portion 41 in which the lamp 1 is housed, and an outer cylindrical portion 42 through which a fluid to be heated flows. A material of the double tube portion 40 is not specifically limited as long as at least the inner cylindrical portion 41 is made of a material that transmits light emitted from the lamp 1. In this embodiment, the entire double tube portion 40 is made of quartz glass. The inner cylindrical portion 41 and the outer cylindrical portion 42 are integrally formed.

In this embodiment, the lamp 1 is housed in the inner cylindrical portion 41 so that the overheat preventing portions 30a and 30b are in contact with the inner cylindrical portion 41. That is, as illustrated in FIG. 7, an outer diameter of the overheat preventing portions 30a and 30b of the lamp 1 is slightly smaller than an inner diameter of the inner cylindrical portion 41. The lamp 1 provided in the inner cylindrical portion 41 is in contact with an inner surface 41a of the inner cylindrical portion 41 via the overheat preventing portions 30a and 30b.

Therefore, heat transferred from the tube portions 11 of the lamp 1 to the overheat preventing portions 30a and 30b by the heat generation and light generation of the filaments 13 is immediately transferred to the double tube portion 40 via the inner surface 41a of the inner cylindrical portion 41.

That is, heat release from the tube portions 11 to the double tube portion 40 via the overheat preventing portions 30a and 30b is effectively achieved. Therefore, the seal portions 12a and 12b of the lamp 1 are effectively prevented from being overheated. The lamp main bodies 10 of the lamp 1 are supported by the overheat preventing portions 30a and 30b in the inner cylindrical portion 41 to be located close to the center of the inner cylindrical portion 41 in the diameter direction.

In this embodiment, the lamp 1 is housed in the inner cylindrical portion 41 so that the seal portions 12a and 12b protrude to the outside of the double tube portion 40. That is, as illustrated in FIG. 7, the one seal portion 12a and the one insulation portion 20a in the lamp 1 are exposed to the outside at one end of the inner cylindrical portion 41, and the other seal portion 12b and the other insulation portion 20b in the lamp 1 are exposed to the outside at the other end of the inner cylindrical portion 41.

Therefore, the seal portions 12a and 12b of the lamp 1 are cooled by air outside the double tube portion 40. Thus, the seal portions 12a and 12b of the lamp 1 are effectively prevented from being overheated.

As illustrated in FIG. 8, the device 3 includes the lamp assembly 2 as described above and a case portion 50 in which the lamp assembly 2 is housed. FIG. 8 illustrates the device 3 in which a side of the case portion 50 is cut.

In the device 3, a current is supplied to the filaments 13 of the lamp 1 to generate heat and light, and the fluid to be heated is caused to flow through the outer cylindrical portion 42 of the double tube portion 40. The fluid flowing from an inlet portion 42a which is one end of the outer cylindrical portion 42 to an outlet portion 42b which is the other end of the outer cylindrical portion 42 is heated by heat from the lamp 1 via an outer wall 41b of the inner cylindrical portion 41.

For example, when a chemical solution to be used for semiconductor and liquid crystal manufacturing is heated by the device 3, it is necessary to heat the chemical solution from around room temperature to a temperature of approximately 150° C. for a relatively short time. In this case, a relatively large current is supplied to the filaments 13 of the lamp 1 immediately after the start of heating, to thereby make the filaments 13 rapidly heat. Therefore, a temperature of the lamp 1 housed in the inner cylindrical portion 41 rapidly increases immediately after the start of heating.

As described above, the lamp 1 includes the overheat preventing portions 30a and 30b, and hence the rising of temperature of the seal portions 12a and 12b immediately after the start of heating is suppressed to be slow, and a maximum temperature reached by the seal portions 12a and 12b is suppressed to a desired range, for example, a range lower than 300° C. In this way, the simple and compact structure is used for the device 3 to efficiently prevent the seal portions 12a and 12b of the lamp 1 from being overheated.

The device 3 is provided with the structure in which a cooling gas is sprayed to at least the seal portions 12a and 12b or the insulation portions 20a and 20b which protrude from the double tube portion 40, and hence the seal portions 12a and 12b are more efficiently prevented from being overheated.

Next, specific examples using the lamp 1 and the device 3 are described.

### EXAMPLES

A halogen lamp including the overheat preventing portions 30a and 30b as illustrated in FIGS. 1 to 6 was uniquely manufactured as the lamp 1. In the halogen lamp, a thermocouple (not shown) having one end connected to the metal foil 16b was encapsulated in one of the seal portions 12b located on the insulation portion 20b side from which the lead wires 18 extend.

As the device 3, an in-line heater in which the lamp 1 connected to the thermocouple was housed in the inner cylindrical portion 41 of the double tube portion 40 as illustrated in FIG. 8 was manufactured. In the device 3, a cooling pipe for spraying cooling air to the seal portions 12a and 12b and the insulation portions 20a and 20b which protrude from the double tube portion 40 was provided in the case portion 50.

Concentrated sulfuric acid was heated using the device 3 until a temperature thereof increased from room temperature to 160° C. That is, the inlet portion 42a and the outlet portion 42b in the device 3 were connected to a storage tank containing concentrated sulfuric acid through chemical resistant tubes. The storage tank was provided with a temperature sensor for measuring the temperature of concentrated sulfuric acid.

Concentrated sulfuric acid was then circulated between the device 3 and the storage tank using a pump. The lamp 1 was turned on by current supply to start heating. After the start of heating, the temperature of the seal portion 12b of the lamp 1 and the temperature of concentrated sulfuric acid contained in the storage tank were monitored.

The amount of concentrated sulfuric acid to be heated was 52.6 L and a flow rate of circulated concentrated sulfuric acid was 40 L/minutes. An output of the lamp 1 (that is, voltage applied to filaments 13) was feedback-controlled based on the measured temperature of concentrated sulfuric acid.

In a first example, cooling air was not sprayed to the seal portions 12a and 12b and the insulation portions 20a and 20b in the device 3. In a second example, the cooling air was sprayed thereto at a flow rate of 25 L/minutes.

In a comparative example, an in-line heater including, as a heating source, a halogen lamp which does not include the overheat preventing portions 30a and 30b (hereinafter referred to as “comparative device”) was manufactured. Also in the comparative device, a thermocouple was encapsulated in a seal portion. Note that the seal portions and insulation portions which were located at both ends of the halogen lamp did not protrude from the double tube portion and thus the entire halogen lamp was housed in the inner cylindrical portion.

As in the case of the device 3 described above, concentrated sulfuric acid was heated using the comparative device until a temperature thereof increased from room temperature to 160° C., and the temperature of the seal portion was monitored. In the comparative example, the amount of concentrated sulfuric acid to be heated was 54 L and a flow rate of circulated concentrated sulfuric acid was 40 L/minutes. Unlike the second example described above, cooling air was not sprayed in the comparative example.

With the halogen lamps used in the first example, the second example, and the comparative example, it was recommended to maintain the seal portions at a temperature lower than 300° C. during the use thereof.

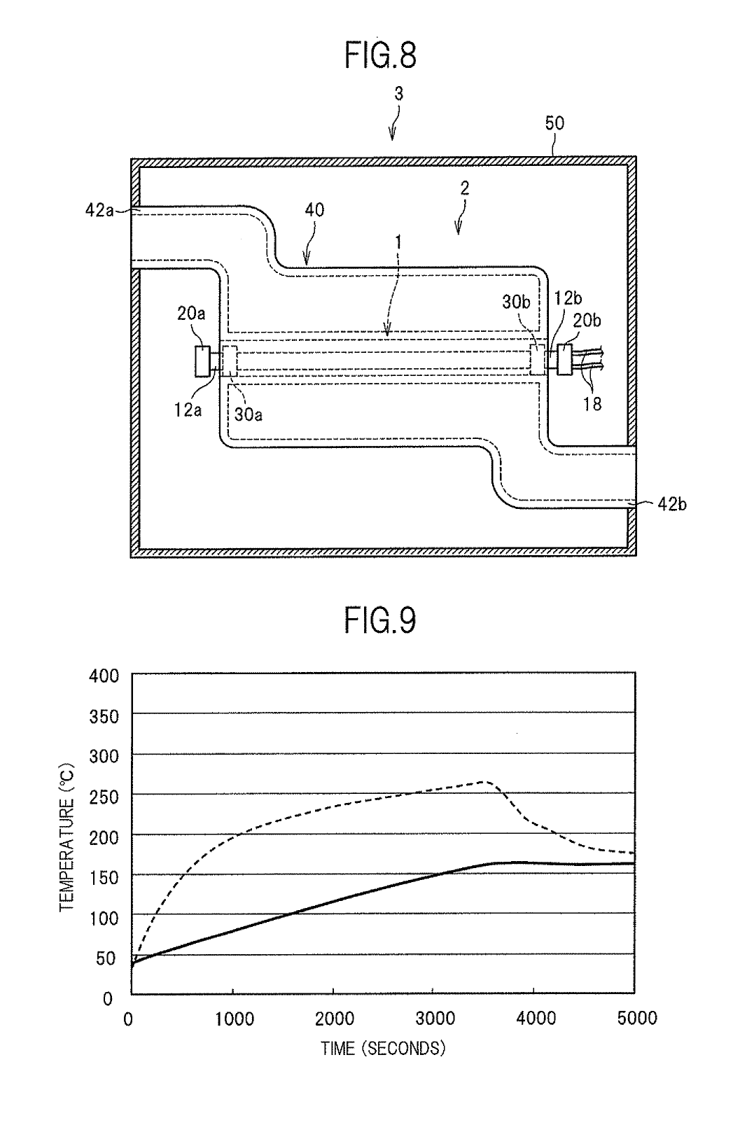

FIG. 9 illustrates temporal changes in temperature of the seal portion 12b and temperature of concentrated sulfuric acid, which were measured in the first example. In FIG. 9, the abscissa indicates an elapsed time (seconds) from the start of heating (that is, the start of current supply to filaments 13 of the lamp 1) and the ordinate indicates a temperature (° C.) measured at each time. In FIG. 9, a broken line indicates the temperature of the seal portion 12b and a solid line indicates the temperature of concentrated sulfuric acid.

As illustrated in FIG. 9, a maximum temperature reached by the seal portion 12b was 264° C. during the increase in temperature of concentrated sulfuric acid from room temperature to 160° C. That is, the temperature of the seal portion 12b was suppressed to a value sufficiently lower than 300° C., which was the upper limit, and hence the seal portion 12b was prevented from being overheated.

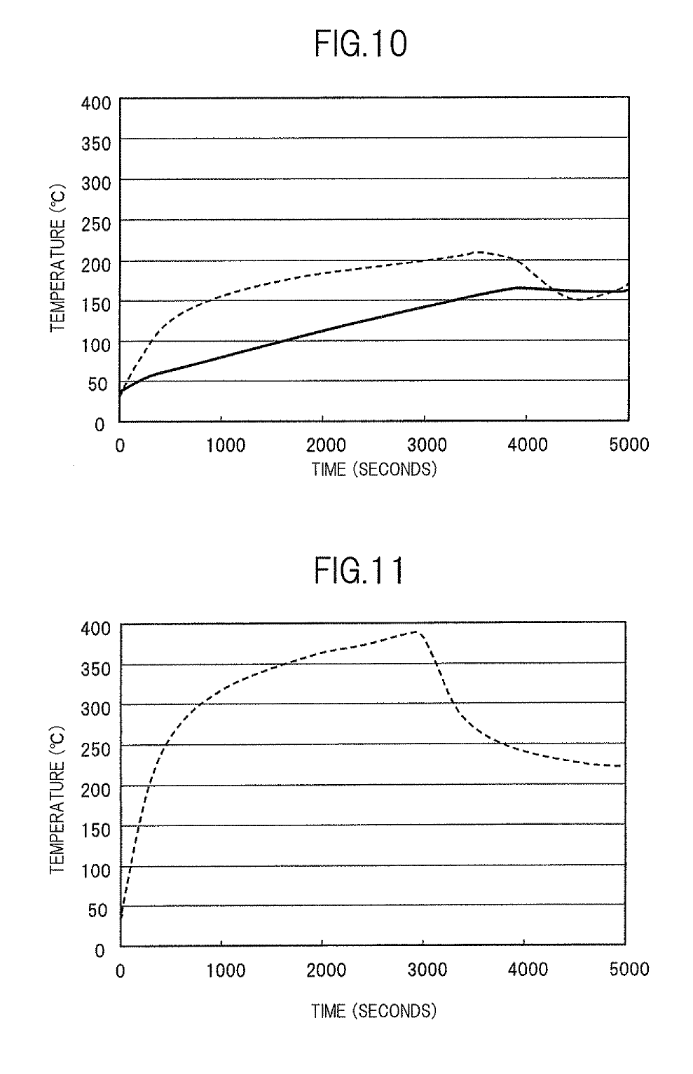

FIG. 10 illustrates temporal changes in temperature of the seal portion 12b and temperature of concentrated sulfuric acid, which were measured in the second example. In FIG. 10, the abscissa indicates an elapsed time (seconds) from the start of heating and the ordinate indicates a temperature (° C.) measured at each time. In FIG. 10, a broken line indicates the temperature of the seal portion 12b and a solid line indicates the temperature of concentrated sulfuric acid.

As illustrated in FIG. 10, a maximum temperature reached by the seal portion 12b was 210° C. during the increase in temperature of concentrated sulfuric acid from room temperature to 160° C. That is, when cooling air is sprayed to the seal portions 12a and 12b, the temperature of the seal portion 12b was suppressed to a value lower than the temperature in the first example.

FIG. 11 illustrates a temporal change in temperature of the seal portion which was measured in the comparative example. In FIG. 11, the abscissa indicates an elapsed time (seconds) from the start of heating and the ordinate indicates a temperature (° C.) measured at each time.

As illustrated in FIG. 11, a maximum temperature reached by the seal portion 12b is 388° C. during the increase in temperature of concentrated sulfuric acid from room temperature to 160° C. That is, in the comparative example in which the lamp 1 was not used, the temperature of the seal portion exceeded 300° C., which was the upper limit, and hence the seal portion was not prevented from being overheated.

A continuous usable time from the start of lighting to the end of lighting due to life-span was measured for the device 3 used in the first example and the comparative device. As a result, the lighting of the halogen lamp of the comparative device was finished after 1,890 hours. In contrast, the lamp 1 of the device 3 was continuously lit for as long as 8,015 hours. That is, when the halogen lamp was provided with the overheat preventing portions 30a and 30b, the life-span of the halogen lamp was significantly extended.

The present invention is not limited to the examples described above. For example, the overheat preventing portions 30a and 30b are not limited to the ones provided closer to the end side with respect to the coil portions 14 of the filaments 13. That is, the overheat preventing portions 30a and 30b may be provided so that a part or the whole thereof covers the outer surfaces of the part of the tube portions 11 which contains the coil portions 14.

The shape and size of the overheat preventing portions 30a and 30b are not limited to the examples described above. That is, the shape of the overheat preventing portions 30a and 30b as viewed from the longitudinal direction of the lamp main bodies 10 is not limited to a circular shape as described above, and thus may be an arbitrary shape, for example, an elliptical shape, a polygonal shape, a beveled polygonal shape, or a concavo-convex shape including a gear or a star.

The shape of the overheat preventing portions 30a and 30b is not limited to a shape protruding to the outsides of the tube portions 11 in the diameter direction in order to block light traveling from the coil portions 14 to the seal portions 12a and 12b. That is, the shape of the overheat preventing portions 30a and 30b is not limited to a protruding shape, such as a shade to block the radiation from the coil portions 14. For example, a thin band shape to cover the outer surfaces 11a of the tube portions 11 may be used.

The material of the overheat preventing portions 30a and 30b is not limited to ceramic and, for example, metal may be used. The metal for the overheat preventing portions 30a and 30b may be aluminum, for example. The ceramic used for the overheat preventing portions 30a and 30b may desirably contain, for example, at least one of aluminum oxide (alumina), silicon nitride, silicon carbide, and zirconia.

In order to reliably bring the overheat preventing portions 30a and 30b and the tube portions 11 into close contact with each other, a sealing material having a heat resistance may be injected into the through holes 31 of the overheat preventing portions 30a and 30b through which parts of the tube portions 11 are inserted, between the overheat preventing portions 30a and 30b and the tube portions 11. The sealing material may be also used as a buffer material for canceling a difference of a thermal expansion coefficient between the overheat preventing portions 30a and 30b and the tube portions 11.

The overheat preventing portions 30a and 30b are desirably made of a non-fiber material or a non-porous material. That is, the overheat preventing portions 30a and 30b may be made of, for example, non-porous ceramic.

The number of lamp main bodies 10 of the lamp 1 is not limited to two. That is, for example, the lamp 1 may include the single lamp main body 10. In this case, the lead wires 18 extend from the insulation portion 20a at one end of the lamp main body 10 and the insulation portion 20b at the other end thereof.

The device 3 is not limited to the device in which the seal portions 12a and 12b of the lamp 1 are provided to protrude to the outside of the double tube portion 40. That is, in the device 3, the seal portions 12a and 12b of the lamp 1 may not protrude to the outside of the double tube portion 40, and the entire lamp 1 may be housed in the inner cylindrical portion 41 of the double tube portion 40.

In the device 3, the fluid to be heated is not specifically limited. For example, sulfuric acid, concentrated sulfuric acid, hydrochloric acid, phosphoric acid, ammonia water, or deionized water, which is used for semiconductor and liquid crystal manufacturing, may be desirably set as the fluid to be heated.

1. A lamp, comprising:
a tube portion in which a filament including a coil portion is housed;
a seal portion in which a metal foil connected to an end of the filament is encapsulated; and
an overheat preventing portion covering an outer surface of the tube portion.

2. The lamp according to claim 1, wherein the overheat preventing portion is provided to cover a part of the outer surface of the tube portion which is closer to the end of the filament with respect to the coil portion of the filament.

3. The lamp according to claim 1, wherein the overheat preventing portion is formed to protrude to the outside of the tube portion in a diameter direction, so as to block light traveling from the coil portion which is generating heat to the seal portion.

4. The lamp according to claim 1, wherein the overheat preventing portion is made of ceramic.

5. A heating device, comprising the lamp according to claim 1 as a heating source.

6. The heating device according to claim 5, further comprising a double tube portion comprising:
an inner cylindrical portion in which the lamp is housed; and
an outer cylindrical portion through which a fluid to be heated flows,
wherein the lamp is housed in the inner cylindrical portion so that the overheat preventing portion is in contact with the inner cylindrical portion and the seal portion protrudes to the outside of the double tube portion.
